(19) United States
(12) Patent Application Publication
(10) Pub. No.: US 2006/0180409 A1
(43) Pub. Date: Aug. 17, 2006

(54) Spring structure and micro-structure employing the same

(75) Inventors: Soon-cheol Kweon, Seoul (KR); Hyung-jae Shin, Seongnam-si (KR); Sang-hun Lee, Seoul (KR); Min-seog Choi, Seoul (KR); Che-heung Kim, Yongin-si (KR); Young-tack Houng, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/315,118

(22) Filed: Dec. 23, 2005

(30) Foreign Application Priority Data
Feb. 15, 2005 (KR) 2005-12390

(51) Int. Cl. F16D 55/02

(52) U.S. Cl. 188/71.8

(57) ABSTRACT

A spring structure for supporting a floating member and a micro-structure having the same. The spring structure includes: at least one support post unit fixed to a substrate; and at least one spring unit having a first spring connected to the support post unit and extending in a predetermined direction from the support post unit, a second spring member connected to a floating member and extending in the same direction as the first spring unit from the floating member, and a connection member arranged normal to the first and second spring members and interconnecting the tip ends of the first and second spring members. Because the first spring member and the second spring member are arranged to be expanded or contracted along with the floating member when the temperature changes, the first and second spring members are not subject to stress caused due to the difference in thermal expansion coefficient.

### CROSS-REFERENCE TO RELATED APPLICATIONS

This application claims priority under 35 U.S.C. § 119 (a) from Korean Patent Application No. 2005-12390 filed on Feb. 15, 2005 in the Korean Intellectual Property Office, the disclosure of which is incorporated herein by reference.

### BACKGROUND OF THE INVENTION

1. Field of the Invention

The present invention relates to a micro-structure, such as an RF (Radio Frequency) switch, a gyroscope, and a micro-mirror, fabricated using a MEMS (Micro Electro Mechanical System) technique, and in particular to a spring structure for supporting a floating member, such as a switch pad, a mass and a floating mirror, and a micro-structure employing such a spring structure.

2. Description of the Related Art

In general, a micro-structure, such as an RF switch, a gyroscope or a micro switch, that is configured using a MEMS technique, includes a spring structure for supporting a floating member, for example, a switch pad, which comes into contact with or moves away from a signal line under the influence of an electrostatic force, thereby switching signal flow, a mass, which constantly vibrates or rotates about a first axial direction, or a floating mirror, which constantly goes up and down. Such a spring structure repeats mechanical deformation and restoration while being operated, whereby stresses are induced and accumulated in the deformed part of the spring structure. Therefore, it is important to prevent the stresses from being accumulated in the deformed part even if the spring structure repeats deformation and restoration while being operated.

FIGS. 1A and 1B schematically show an example of a conventional RF switch employing a spring structure.

The RF switch 1 includes a switch pad 16 which comes into contact with or moves away from signal lines 32, 33, thereby switching signal flow, and a spring structure 10 for elastically supporting the switch pad 16.

The switch pad 16 is formed from a multi-layered film having a metallic layer 28 and first and second insulation layers 27, 29, such as silicon nitride layers, deposited on top and bottom sides of the metallic layer 28, respectively, wherein the switch pad 16 includes first and second terminal connection units 30a, 30b each formed on the bottom side of the opposite ends 16a, 16b of the switch pad, in which the first and second terminal connection units come into contact with or move away from first and second switching terminals 32a, 32b; 33a, 33b of the signal lines 32, 33.

The spring structure 10 includes a support post 21, and first and second springs 22, 23. The support post 21 is provided on a ground 15 formed on a substrate 11 and vertically projected into an opening 25 formed through the central part of the switch pad 16. The first and second springs 22, 23 are interposed between the front and rear side walls of the opening 25 of the switch pad 16 and the front and rear sides of the support post 21, respectively, thereby interconnecting the corresponding parts of the opening 25 and the support post 21. The first and second springs 22, 23 are formed from the same metallic material as the metallic layer 28 of the switch pad 16.

FIGS. 2A and 2B schematically show another example of a conventional RF switch 1′ employing a spring structure.

The RF switch 1′ includes a switch pad 16′ and a spring structure 10′ like the RF switch 1 shown in FIGS. 1A and 1B.

The RF switch structure 10′ includes first and second support posts 21a, 22b and first and second springs 22a, 23a. The first and second support posts 21a, 21b are provided on a ground 15 formed on a substrate 11, adjacent to the rear and front edges 16c, 16d of the switch pad 16′, respectively, wherein the first and second posts 21a, 21b are vertically projected. The first and second springs 22a, 23a are interposed between the rear and front edges 16c, 16d of the switch pad 16′ and the upper parts of the first and second support posts 21a, 21b, respectively. The first and second springs 22a, 23a are formed from the same metallic material as the metallic layer 28 of the switch pad 16′.

Because such conventional RF switches 1, 1′ have an arrangement provided with the spring structure 10; 10′, in which the first and second springs 22, 23; 22a, 23a supports the internal walls of the opening 25 of the switch pad 16 or the rear and front edges 16c, 16d, the switch pad 16; 16′ can be elastically supported in a relatively stable manner.

However, because the first and second springs 22, 23; 22a, 23a of the spring structure 10; 10′ are formed form a metallic material and the switch pad 16; 16′ is formed from a multi-layered film of first insulation layer-metallic layer-second insulation layer 27, 28, 29, the first and second springs 22, 23; 22a, 23a and the switch pad 16; 16′ have different thermal expansion coefficients. Accordingly, if the switch pad 16; 16′ is expand or contracted depending on the change of temperature within and/or around the RF switch while the RF switch operates, the first and second springs 22, 23; 22a, 23a cannot be expanded or contracted along with the switch pad 16; 16′ because the springs 22, 23; 22a, 23a are fixed to the support post(s) 21; 21a, 21b. Consequently, stresses are induced the springs 22, 23; 22a, 23a in proportion to the difference in heat expansion coefficient between the springs 22, 23; 22a, 23a and the switch pad 16; 16′. Such stresses may have an influence on the function of the first and second springs 22, 23; 22a, 23a, thereby making the operation of the switch pad 16; 16′ unstable. Furthermore, if the stresses are excessive, plastic deformation may be caused in the first and second springs 22, 23; 22a, 23a.

In order to solve these problems, it can be considered to form the first and second springs 22, 23; 22a, 23a from a multilayered film of first insulation layer-metallic layer-second insulation layer 27, 28, 29 like the switch pad 16; 16′. If so, however, there arises a problem in that due to the first and second insulation layers 27, 29, the first and second springs 22, 23; 22a, 23a cannot secure a rotational torsional elastic force required for switching the switch pad 16; 16′.

To the contrary, if the switch pad 16; 16′ is formed from the same metallic material as the first and second springs 22, 23; 22a, 23a, there arises a problem in that the switch pad 16; 16′ cannot perform the function of switching signal flow because the switch pad 16; 16′ is not insulated from the first and second terminal connection units 30a, 30b.

### SUMMARY OF THE INVENTION

Accordingly, the present invention has been made in view of the above-mentioned problems, and an apparatus consistent with the present invention provides a spring structure for supporting a floating member, such as a switch pad, a mass, or a floating mirror, and a micro-structure employing such a spring structure, in which the spring structure is structurally improved in such a manner that the spring structure can be expanded or contracted along with the floating member when temperature changes, whereby stresses caused by the difference in thermal expansion coefficient between the floating member and the spring structure is not induced in the spring structure.

More specifically, there is provided a spring structure comprising: at least one support post unit fixed to a substrate; and at least one spring unit comprising a first spring member connected to the support post unit and extending in a predetermined direction from the support post unit, a second spring member connected to a floating member and extending in the same direction as the first spring member from the floating member, and a connection member interconnecting tip ends of the first and second spring members.

The spring unit may further comprise a sagging prevention member formed on the connection member to be opposite to the substrate. The sagging prevention member may comprise at least one projection.

It is preferred, but not necessary, that a part connected with the first spring member in the support post unit, the floating member and the connection member are formed from a same material having a first thermal expansion coefficient, and the first and second spring members are formed from a same material having a second thermal expansion coefficient.

The support post unit and the spring unit may be located in an opening formed through a central portion of the floating member or provided in at least one of two opposite edges of the floating member.

If the support post unit and the spring unit are provided in the opening formed through the central portion of the floating member, a part connected with the first spring member in the support post unit and a part of the floating member connected to the second spring member may have a same width in a longitudinal direction of the first and second spring members.

In addition, the support post unit may comprise a support post vertically arranged in the opening formed through the floating member, the first spring member may comprise a first spring connected to the support post and extending in the predetermined direction from the support post, the second spring member may comprise second and third springs connected to the floating member in the opening and extending in the same direction as the first spring from the floating member, and the connection member comprises a connection bar arranged normal to the first, second and third springs and interconnecting the tip ends of the first, second and third springs.

If the support post unit and the spring unit are provided in the one edge of the two opposite edges of the floating member, the support post unit may comprise first and second support posts vertically arranged in first and second slits, respectively, in which the first and second slits are formed in the one edge with a predetermined distance between them, the first spring member may comprise first and second springs connected to the first and second support posts and extending in the predetermined direction from the first and second support posts, respectively, the second spring member may comprise a third spring connected to the floating member between the first and second slits and extending in the same direction as the first and second springs from the floating member, and the connection member may comprise a connection bar interconnecting tip ends of the first, second and third springs.

According to another aspect of the present invention, there is provided a micro-structure comprising: a substrate; a floating member; and a spring structure for supporting the floating member in such a manner that the floating member is retained in floating state above the substrate with a gap being formed between the substrate and the floating member, wherein the spring structure comprises: at least one support post unit fixed to a substrate; and at least one spring unit comprising a first spring member connected to the support post unit and extending in a predetermined direction from the support post unit, a second spring member connected to a floating member and extending in the same direction as the first spring member from the floating member, and a connection member arranged normal to the first and second spring members and interconnecting the tip ends of the first and second spring members.

The spring unit may further comprise a sagging prevention member formed on the connection member to be opposite to the substrate. In addition, the sagging prevention member preferably comprises at least one projection.

A part connected with the first spring member in the support post unit, the floating member and the connection member may be formed from a same material having a first thermal expansion coefficient, and the first and second spring members may be formed from a same material having a second thermal expansion coefficient.

The support post unit and the spring unit may be provided in an opening formed through a central portion of the floating member or in one of two opposite edges of the floating member.

If the support post unit and the spring unit are provided in the opening formed through the central portion of the floating member, a part connected with the first spring member in the support post unit and a part connected with the second spring member in the floating member may have a same width in a longitudinal direction of the first and second spring members.

In addition, the support post unit may comprise a support post vertically arranged in the opening formed through the floating member, the first spring member may comprise a first spring connected to the support post and extending in a predetermined direction from the support post, the second spring member may comprise second and third springs connected to the floating member in the opening and extending in the same direction as the first spring from the floating member, and the connection member may comprise a connection bar arranged normal to the first, second and third springs and interconnecting the tip ends of the first, second and third springs.

If the support post unit and the spring unit are provided in the at least one edge of the two opposite edges of the floating member, the support post unit may comprise first and second support posts vertically arranged in first and second slits, respectively, in which the first and second slits are formed in the edge with a predetermined distance, the first spring member may comprise first and second springs connected to the first and second support posts and extending in the predetermined direction from the first and second support posts, respectively, the second spring member may comprise a third spring connected to the floating member between the first and second slits and extending in the same direction as the first and second springs from the floating member, and the connection members may comprise a connection bar arranged normal to the first, second and third springs and interconnecting the tip ends of the first, second and third springs.

According to an exemplary embodiment of the present invention, the micro-structure may be a micro switch, the substrate may comprise at least one signal line, and at least one electrostatic driving unit, and the floating member may comprise a switch pad having plural terminal connection units, which come into contact with or move away from switching terminals of the signal line in response to movement of the electrostatic driving unit.

### BRIEF DESCRIPTION OF THE DRAWINGS

The above aspects and features of the present invention will be more apparent from the description for exemplary embodiments of the present invention taken with reference to the accompanying drawings, in which:

FIG. 1A is a schematic perspective view exemplifying a conventional RF switch employing a spring structure;

FIG. 1B is a cross-sectional view taken along line I-I of FIG. 1;

FIG. 2A is a schematic perspective view exemplifying another conventional RF switch employing a spring structure;

FIG. 2B is a cross-sectional view taken along line II-II of FIG. 2A;

FIG. 3 is a schematic perspective view of an RF switch employing a spring structure according to a first embodiment of the present invention;

FIGS. 4A and 4B are partial sectional views taken along lines III-III and IV-IV of FIG. 3, respectively;

FIG. 5 is a schematic perspective view of an RF switch employing a spring structure according to a second embodiment of the present invention; and

FIGS. 6A and 6B are partial sectional views taken along lines V-V and VI-VI, respectively.

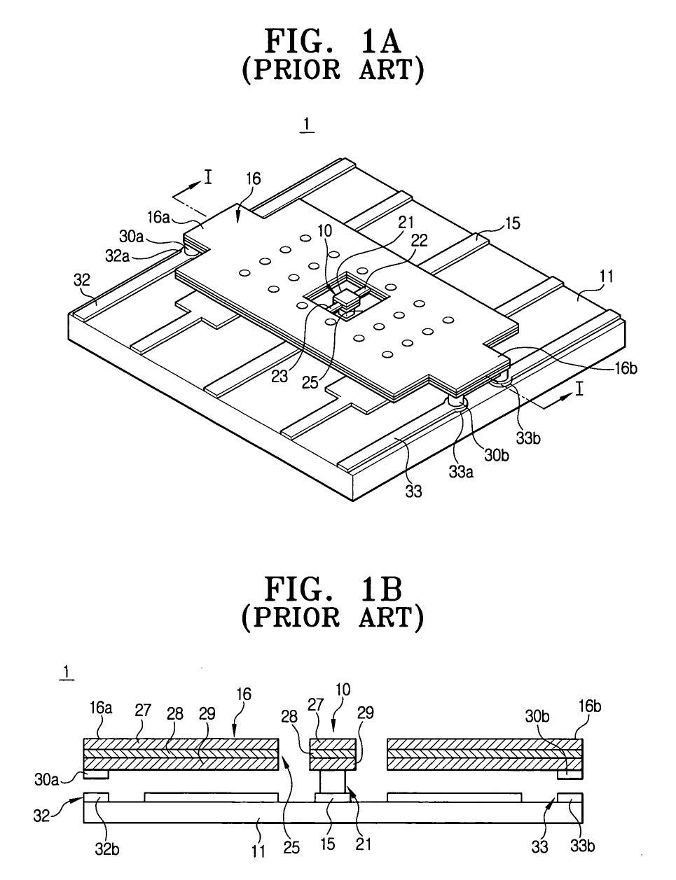

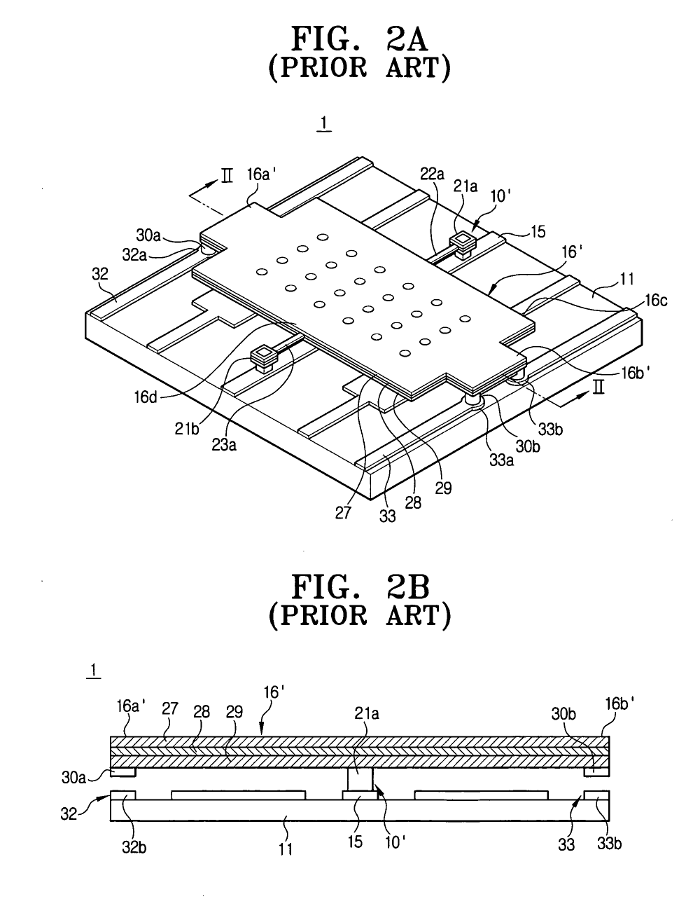

### DETAILED DESCRIPTION OF ILLUSTRATIVE, NON-LIMITING EMBODIMENTS OF THE INVENTION

Hereinbelow, the exemplary embodiments of the present invention are described in detail with reference to accompanying drawings.

### First Embodiment

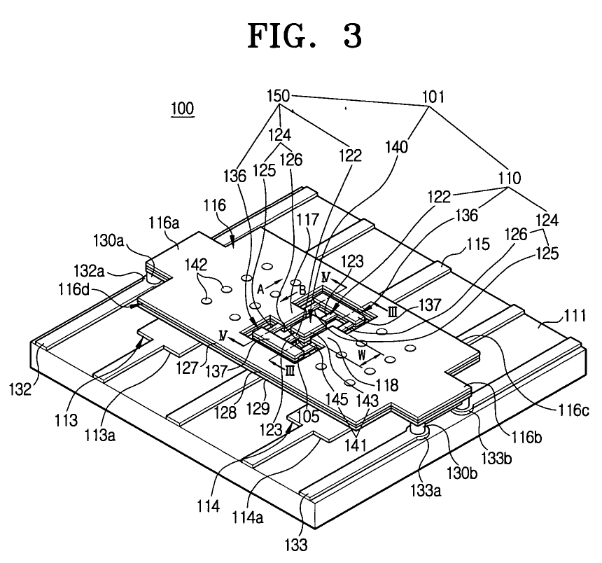

FIG. 3 schematically shows a micro-structure, to which a spring structure according to a first embodiment of the present invention is applied.

The micro-structure employing the spring structure according to the first embodiment is an RF switch 100 for switching signal flow.

The RF switch 100 comprises a substrate 111, first and second signal lines 132, 133, first and second electrostatic driving units 113, 114, a switch pad 116, and a spring structure 110.

The first and second signal lines 132, 133 are provided on the left and right sides of the top surface of the substrate 111. The first and second signal lines 132, 133 are formed from a conductive metallic material such as gold (Au), silver (Ag) and copper (Cu).

The first and second electrostatic driving units 113, 114 are positioned inside between the first and second signal lines 132, 133 on the substrate 111. The first and second electrostatic driving units 113, 114 include first and second electrodes 113a and 114a formed from a metallic material, such as gold (Au) silver (Ag) or the like, that has a good conductivity.

The switch pad 116 is elastically supported above the substrate 111 by the spring structure 101, wherein the switch pad is formed from a multi-layered film having a metallic layer 128 formed from a metallic material such as aluminum (Al), and first and second insulation layers 127, 129 formed from silicon nitride film or the like and deposited on the top and bottom sides of the metallic layer 128.

The switch pad 116 has first and second terminal connection units 130a, 130b in a shape of “ [symbol] ” formed on the bottom sides of first and second ends 116a, 116b thereof, respectively. The first and second terminal connection units 130a, 130b come into contact with or move away from first and second switching terminals 132a (only one is shown in FIG. 3); 133a, 133b to interconnect or cut off the first and second switching terminals 132a; 133a, 133b, wherein the first and second terminal connection units 130a, 130b are formed from a metallic material such as gold (Au), Ag (Ag) or the like, that has a good conductivity.

In addition, the switch pad 116 may have a plurality of etching holes 142 so as to facilitate an etching process for forming the first and second signal lines 132, 133, and the first and second electrodes 113a, 114a or the like underneath the switch pad 116 at the time of manufacturing the micro-structure.

The spring structure 101 elastically supports the switch pad 116 in such a manner that the switch pad 116 can float above the substrate 111, wherein the spring structure 101 comprises a support post unit 140, and rear and front spring units 110, 150.

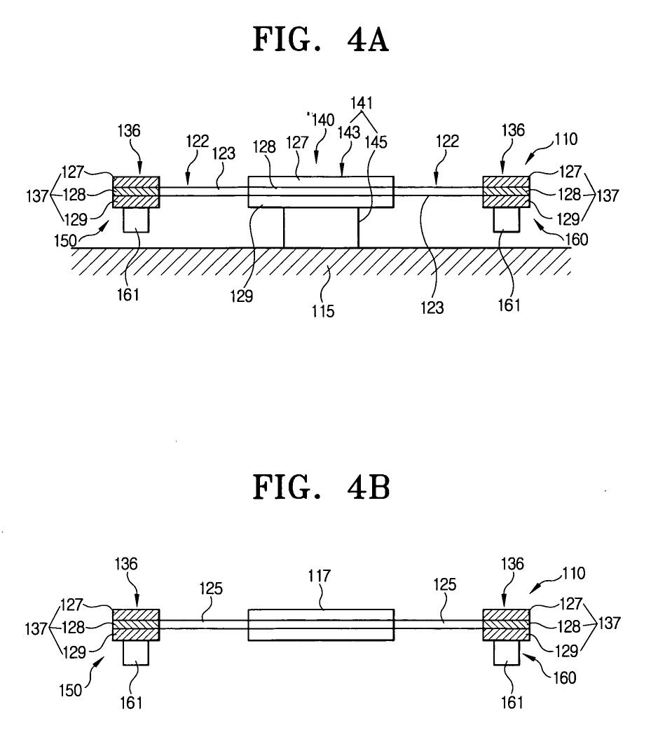

As shown in FIG. 4A, the support post unit 140 comprises a support post 141 fixed to a ground 115 formed on the substrate 111 at the center of an H-shaped opening 105 formed through the middle portion of the switch pad 116. The support post 141 comprises a lower part 145 fixed to the ground 115 and an upper part 143 located on the lower part 145 at the same level as the switch pad 116.

The upper part 143 of the support post 141 is formed from the same multi-layered film as the switch pad 116, so that the upper part 143 of the support post 141 has the same heat expansion coefficient as the switch pad 116, wherein the multi-layered film has a metallic layer 128 formed from a metallic material such as aluminum (Al), and first and second insulation layers 127, 129 formed from an insulation material such as silicon nitride film and deposited on the top and bottom sides of the metallic layer 128, respectively. Accordingly, the upper part 143 of the support post 141 can be formed concurrently with the switch pad 115 in the manufacturing process.

In addition, the upper part 143 of the support post 141 has the same width W as the first and second spring retaining parts 117, 118 of the switch pad 116 in the rearward or forward direction (arrow A or B in FIG. 3), so that the upper part 143 of the support post 141 can be expanded or contracted to the same extent as the first and second spring retaining part 117, 118 when the upper part 143 is expanded or contracted as the temperature within or around the RF switch changes.

The rear and front spring units 110, 150 are arranged in the opening 105 symmetrical to each other with reference to a horizontal central axis of the switch pad 116 between the rear edge 116c and the front edge 116d thereof.

The rear spring unit 110 comprises a first spring member 122, a second spring member 124 and a connection member 136.

The first spring member 122 comprises first spring 123 connected to the rear side of the upper part 143 of the support post 141 and extending from the rear side of the upper part 143 of the support post 141 in the directions indicated by arrow A. The first spring 123 is formed from the same material as the metallic layer 128 of the switch pad 116, i.e., from a metallic material such as aluminum (Al).

The second spring member 124 comprises second and third springs 125, 126 connected to the rear edges of the first and second spring retaining parts 117, 118 of the switch pad 116, respectively, in which the spring retaining parts 117, 118 are projected into the opening 105 from the left and right walls of the opening 105, and the second and third springs 125, 126 extend from the rear edges of the first and second spring retaining parts 117, 118 in the direction indicated by arrow A. The second and third springs 125, 126 are formed from the same material as the first spring 123, i.e., from a metallic material such as aluminum (Al), so that they have the thermal expansion coefficient as the first spring 123. Accordingly, the first, second and third springs 123, 125, 126 can be formed concurrently with the metallic layer 128 of the switch pad 116 in the manufacturing process.

The connection member 136 comprises a connection bar 137 arranged normal to the first, second and third springs 123, 125, 126, so that the connection bar 137 interconnects the tip ends of the first, second and third springs 123.

As shown in FIGS. 4A and 4B, the connection bar 137 is not connected with any other part beyond the rear tip ends of the first, second and third springs 123, 125, 126, so that they can be freely displaced above the substrate 111. Accordingly, when the switch pad 116 and the first, second and third springs 123, 125, 126 are expanded or contracted due to the change in temperature caused within or around the RF switch 100, the connection bar 137 can be displaced in the front or rear direction (arrow A or B) by an extent corresponding to the deformation of the switch pad 116 and the first, second and third springs 123, 125, 126, whereby the stresses induced in the first, second and third springs 123, 125, 127 due to the difference in thermal expansion coefficient between the switch pad 116 and the first, second and third springs 123, 125, 126 can be dispersed.

The connection bar 137 can be formed from the same multi-layered film as the switch pad 116, i.e., from a multi-layered film having a metallic layer 128, and first and second insulation layers 127, 129 formed from an insulation material such as silicon nitride films and deposited on the top and bottom sides of the metallic layer 128. Therefore, the connection bar 137 can be formed concurrently with the switch pad 116 and the upper part 143 of the support post 141 in the manufacturing process.

In this manner, the first and second spring retaining parts 117, 118 and the upper part 143 of the support post 141 have an identical width W in the rearward or forward direction (arrow A or B) and they are formed from the same material, i.e., from a multi-layered film having first insulation layer-metallic layer-second insulation layer 127, 128, 129. In addition, the first, second and third springs 123, 125, 126 can be formed from the same material such as aluminum (Al) with the same size in the rearward or forward direction (arrow A or B), and the connection bar 137 connected to the first, second and third springs 123, 125, 127 can be formed from the above-mentioned multi-layered film of first insulation layer-metallic layer-second insulation layer 127, 128, 129 with a same size in the rearward or forward direction (arrow A or B). Therefore, if the switch pad 116, and the first, second and third springs 123, 125, 126 are expanded or contracted as temperature changes while the RF switch 100 operates, the extent, to which the first and second spring retaining parts 117, 118 of the switch pad 116, the second and third springs 125, 126, and the parts connected with the second and third springs 125, 126 in the connection bar 137 are deformed in the direction indicated by arrow A or B, will be the same in the extent, to which the upper part 143 of the support post 141, the first spring 123 and the portion connected with the first spring 123 in the connection bar 137 are deformed in the direction indicated by arrow A or B. At this time, the force exerted on the first and second spring retaining parts 117, 118 of the switch pad 116, the second and second springs 125, 126, the upper part 143 of the support post 141, and the first spring 123 will be finally transferred to the connection bar 137. However, because the connection bar 137 can be freely displaced without being fixed to the substrate 111 or the like, the force will be absorbed or disappear by the deformation or displacement of the connection bar 137 either in the forward or reward direction (arrow A or B). Therefore, even if the switch pad 116, and the first, second and third springs 123, 125, 126 are expanded or contracted due to the change of temperature, the first spring 123 and/or the second and third springs 125, 126 are not subject to stresses, as a result of which the first spring 123 and/or the second and third springs 125, 126 are prevented from being functionally deteriorated or plastically deformed by the stresses.

As shown FIGS. 4A and 4B, the rear spring unit 110 may further comprise a sagging prevention member formed on the bottom side of the connection member 137 to be opposite to the substrate 111 so as to prevent from the connection bar 137 of the connection member 136 and the first, second and third springs 123, 125, 126 from coming into contact with the substrate 111 due to excessive deformation thereof caused when the switch pad 116 and the first, second and third springs 123, 125, 126 are expanded or contracted as the temperature changes. The sagging prevention member 160 may comprise at least one projection, preferably, but not necessarily, three projections 161 depending from the bottom side of the connection bar 137 and spaced from one another (only one projection is shown in FIGS. 4A and 4B).

The front spring unit 150 of the spring structure 101 is structurally the same with the rear spring unit 110, except that the front spring unit 150 is positioned symmetrically to the rear spring unit 110 with reference to the horizontal central axis of the switch pad 116 between the rear edge 116c and the front edge 116d thereof. Therefore, the construction and action of the front spring unit 150 are not further described here.

Although it has been exemplified and described above that the spring structure 101 of the inventive RF switch 100 has an arrangement in which the rear and front spring units 110, 150 are arranged symmetrical to each other, it is possible to use only one of the rear and front spring units 110, 150 and to configure the one spring unit in a cantilevered form.

In addition, although it has been exemplified and described above that the inventive spring structure 101 is applied to an RF switch 100 for switching signal flow, the invention is not limited to this. Rather, the present invention can be also applied to a device employing a floating member that performs vertical seesaw movement under the influence of an electrostatic force when power is applied to the first and second electrodes 113a, 114a, for example, a gyroscope employing a mass such as a vibration piece that vibrates or turns in a predetermined direction under the influence of an electrostatic force, or a micro mirror employing a floating mirror that vertically vibrates under the influence of an electrostatic force.

Now, the action of the RF switch 100 employing the inventive spring structure 101 is described in detail with reference to FIGS. 3 to 4B.

Firstly, if a voltage is applied to one of the first and second electrodes 113a, 114a of the first and second electrostatic driving units 113, 114, for example, to the second electrode 114a, an electrostatic force is generated between the second electrode 114a and a part opposite to the second electrode 114a in the switch pad 116, and the second end 116b of the switch pad 116 is downwardly drawn by the electrostatic force. As a result, the switch pad 116 is tilted about the first springs 123, 123 of the first spring members 122, 122 of the rear and front spring units 110, 150 like a seesaw against the rotational torsional rigidity of the first springs 123, 123. Therefore, the second terminal connection unit 130b of the switch pad 116 comes into contact with the first and second switching terminals 133a, 133b of the corresponding second signal line 133, thereby interconnecting the first and second switching terminals 133a, 133b. As a result, the second signal line 133 is turned “ON,” whereby signals flow through the second signal line 133.

To the contrary, if the supply of the voltage to the second electrode 114a of the second electrostatic driving unit 114 is blocked, the electrostatic force disappears between the second electrode 114a and the part opposite to the second electrode 114a in the switch pad 116, whereby the second end 116b of the switch pad 116 is lifted and returned to its original position by the torsional rigidity of the first springs 123, 123. As a result, the second terminal connection unit 130b of the switch pad 116 moves away from the first and second switching terminals 133a, 133b, thereby cutting off the first and second switching terminals 133a, 133b. As a result, the second signal line 133 is turned “OFF,” thereby blocking the signal flow.

### Second Embodiment

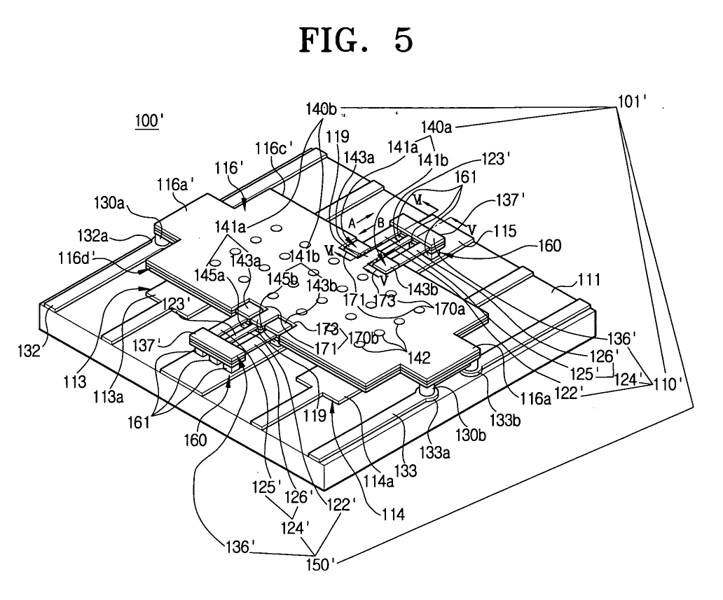

FIG. 5 schematically shows a micro-structure, to which the spring structure according to the second embodiment of the present invention is applied.

The micro-structure, to which the spring structure according to the second embodiment of the present invention is an RF switch 100′.

The RF switch 100′ comprises a substrate 111, first and second signal lines 132, 133, first and second electrostatic driving units 113, 114, a switch pad 116′, and a spring structure 101′.

The arrangement and action of the components of this RF switch 100′ are same with those of the RF switch 100 of the first embodiment described above with reference to FIGS. 3 to 4B, except for the switch pad 116′ and the spring structure 101′.

The switch pad 116′ is same as the switch pad 116 of the RF switch 100 of the first embodiment, except that the switch pad 116′ is formed with first and second slit sections 170a, 170b in the rear edge 116c′ and front edge 116d thereof for mounting the rear and front support units 140a, 140b of the spring structure 101′, wherein the first and second slits 170a, 170b will be described later.

Each of the first and second slit sections 170a, 170b comprises first and second slits 171, 173 formed in the rear edge 116c′ or the front edge 116d′ with a predetermined distance between them.

The spring structure 101′ elastically supports the switch pad 116′ in such a manner that the switch pad 116′ can float above the substrate, wherein the spring structure 101′ comprises rear and front support post units 140a, 140b and rear and front spring units 110′, 150′.

The rear and front support post units 140a, 140b are arranged symmetrical to each other with reference to the horizontal central axis of the switch pad 116 between the rear edge 116c′ and front edge 116d′. Each of the rear and front support post units 140a, 140b comprises first and second support posts 141a, 141b.

The first and second support posts 141a, 141b are fixed to the ground 115 at the first and second slits 171, 173 of the first and second slit sections 170a, 170b, wherein each of the rear and front edges 116c′, 116d is formed with the first and second slit sections 170a, 170b.

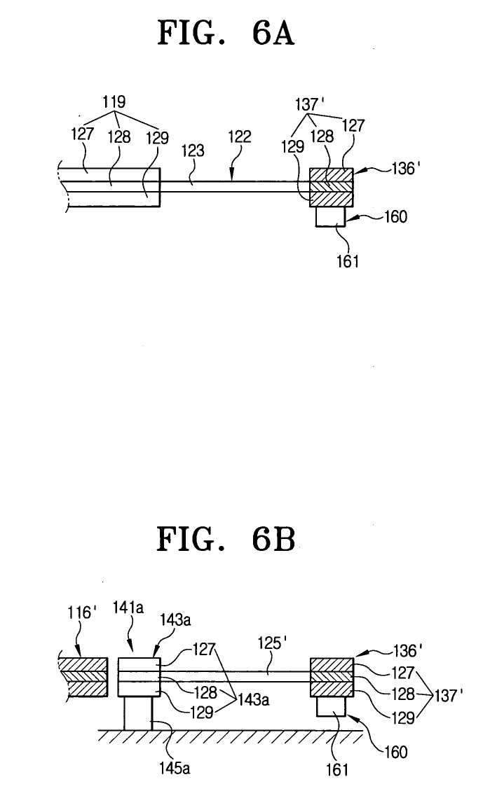

Each of the first and second support posts 141a; 141b has a lower part 145a; 145b fixed to the ground 115, and an upper part 143a; 143b located on the lower part 145a; 145b at the same height as the switch pad 116′. As shown in FIG. 6B, the upper parts 143a, 143b are formed from the same material as the switch pad 116′, so that the upper parts 143a, 143b have a thermal expansion coefficient same with that of the switch pad 116′; that is, the upper parts 143a, 143b are formed from a multi-layered film comprising a metallic layer 128 and first and second insulation layers 127, 129 deposited on the top and bottom sides of the metallic layer 128, wherein the insulation layers 127, 129 are formed from an insulation material such as a silicon nitride film.

Like the rear and front support post units 140a, 140b, the front and rear spring units 110′, 150′ are arranged symmetrical to each other with reference to the horizontal central axis of the switch pad 116′ between the rear edge 116c′ and the front edge 116d′.

The rear spring unit 110′ comprises a first spring member 124′, a second spring member 122′ and a connection member 136′.

The first spring member 124′ comprises first and second springs 125′ and 126′, which are connected to the upper parts 143a, 143b of the first and second support posts 141a, 141b and extend in the rearward direction (indicated by arrow A in FIG. 5) from the rear sides of the upper parts 143a, 143b. The first and second springs 125′ and 126′ are formed from the same material as the metallic layers 128 of the upper parts 143a, 143b of the first and second support posts 141a, 141b and the switch pad 116′, i.e., from a metallic material such as aluminum (Al).

As shown in FIG. 6A, the second spring member 122′ comprises a third spring 123′ which is connected to the rear edge of the spring retaining part 119 of the switch pad 116′ and extends from the rear edge of the spring retaining part 119 in the rearward direction (arrow A), in which the spring retaining part 119 is positioned between the first and second slits 171, 172. The third spring 123′ is formed from the same material as the first and second springs 125′, 126′, so that the third spring 123′ has a thermal expansion coefficient which is the same as that of the first and second springs 125′, 126′; that is, the third spring 123′ is formed from a metallic material such as aluminum (Al).

The connection member 136′ comprises a connection bar 137′, which is arranged normal to the first, second and third springs 125′, 126′, 123′ and interconnects the tip ends of the first, second and third springs 125′, 126′, 123′. As shown in FIGS. 6A and 6B, the connection bar 137′ is formed from the same material as the switch pad 116′; that is, the connection bar is preferably, but not necessarily, formed from a multi-layered film a metallic layer 128 and first and second insulation layers 127, 129 formed from an insulation material, such as silicon nitride film deposited on the top and bottom sides of the metallic layer 128.

The connection bar 137′ is not connected to any other part except the tip ends of the first, second and third springs 125′, 126′, 127′, so that the connection bar 137′ can be freely displaced above the substrate 111.

Therefore, when the switch pad 116′ and the first, second and third springs 125′, 126′ 123′ are expanded or contracted as the temperature is changed within or around the RF switch 100′, the connection bar 137′ can be displaced in the rearward or forward direction (arrow A or B in FIG. 5) to an extent corresponding to the deformation of the switch pad 116′ and the first, second and third springs 125′, 126′, 123′, whereby the stresses induced in the first, second and third springs 125′, 126′, 123′ by the difference in thermal expansion coefficient between the switch pad 116′ and the first, second and third springs 125′, 126′, 123′ can be dispersed.

More specifically, if the switch pad 116′ and the first, second and third springs 125′, 126′, 123′ are expanded or contracted due to the change of temperature caused when the RF switch 100′ operates, the spring retaining part 119 of the switch pad 116′, the upper parts 143a, 143b of the first and second support posts 141a, 141b, the first, second and third springs 125′, 126′, 123′, and the parts connected with the first, second and third springs 125′, 126′, 123′ in the connection bars 137′ will be expanded or contracted in the rearward or forward direction (arrow A or B). In this situation, however, because the spring retaining part 119 of the switch pad is different from the upper parts 143a, 143b of the first and second support posts 141a, 141b in width in the forward or rearward direction (arrow A or B), the extent, to which the spring retaining part 119 of the switch pad 116′ is expanded or contracted due to the change of temperature, is infinitestimally different from the extent, to which the upper parts 143a, 143b of the first and second support posts 141a, 141b are expanded or contracted due to the change of temperature. In such a case, however, because the connection bar 137′ is displaced in the reward or forward direction (indicated by arrow A or B) by an amount corresponding to the deformation of the switch pad 116′ and the first, second and third springs 125′, 126′, 123′, thereby serving to absorb or disperse the stresses induced in the third spring 123′ and/or the first and second springs 125′, 126′ due to the difference in thermal expansion coefficient between the switch pad 116′, the third spring 123′, and the first and second springs 125′, 126′, the stresses induced in the third spring 123′ and/or the first and second springs 125′, 126′ substantially disappear. Therefore, even if the switch pad 116′ and the first, second and third springs 125′, 126′, 123′ are expanded or contracted as the temperature changes, the functional deterioration or plastic deformation of the third spring 123′ and/or the first and second springs 125′, 126′ caused by the stresses can be substantially reduced.

As shown in FIGS. 5, 6A and 6B, the rear spring unit 110′ may further comprise a sagging prevention member 160 depending from the bottom side of the connection bar 137′ to be opposite to the substrate 111 so as to prevent the first, second and third springs and the connection bar 137′ of the connection member 136′ from coming into contact with the substrate 111 due to the excessive deformation thereof caused when the switch pad 116′ and the first, second and third springs 125′, 126′, 123′ are expanded or contracted as the temperature changes. Like the RF switch 100 of the first embodiment, the sagging prevention member 160 may comprise at least one projection, preferably, but not necessarily, three projections 161 formed on the bottom side of the connection bar 137′ with a predetermined space between them.

The front spring unit 150′ is structurally the same as the rear spring unit 110′, except that it is arranged symmetrical to the rear spring unit 110′ with reference the horizontal central axis of the switch pad 116′ between the rear edge 116c′ and the front edge 116d′.

The action of the RF switch 100′ having the spring structure 101′ of the second embodiment of the present invention configured as described above is identical to that of the RF switch 100 of the first embodiment described above with reference to FIGS. 3 to 4B. Therefore, detailed description thereof is omitted.

As described above, because the inventive spring structure and a micro-structure employing the same have an arrangement that allows a first spring member connected to a support post unit and a second spring member for supporting a floating member, such as a switch pad, a mass or a floating mirror, to be expanded or contracted along with the floating member when the temperature changes, the first and second spring members are not subject to stresses induced from the floating member due to the difference in thermal expansion coefficient between the first and second spring members and the floating member even if the floating member is expanded or contracted as the temperature changes. Therefore, because the first and second spring members are prevented from being functionally deteriorated or plastically deformed due to stresses, the spring structure and the micro-structure, such as an RF switch or a gyroscope, that employs such a spring structure, exhibits high driving performance and reliability. In addition, because the temperature, which can be endured by the spring structure and the micro-structure employing such a spring structure is increased, the temperature limitation allowed in fabricating, packaging and mounting such a micro-structure is also increased, whereby the micro-structure can be more easily applied to a manufacturing process.

Although representative embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. A spring structure comprising:
at least one support post unit fixed to a substrate; and
at least one spring unit comprising a first spring member connected to the support post unit and extending in a predetermined direction from the support post unit, a second spring member connected to a floating member and extending in the same direction as the first spring member from the floating member, and a connection member interconnecting tip ends of the first and second spring members.

2. The spring structure as claimed in claim 1, wherein the spring unit further comprises a sagging prevention member formed on the connection member to be opposite to the substrate.

3. The spring structure as claimed in claim 2, wherein the sagging prevention member comprises at least one projection.

4. The spring structure as claimed in claim 1, wherein a part connected with the first spring member in the support post unit, the floating member and the connection member are formed from a same material having a first thermal expansion coefficient, and
the first and second spring members are formed from a same material having a second thermal expansion coefficient.

5. The spring structure as claimed in claim 1, wherein the support post unit and the spring unit are located in an opening formed through a central portion of the floating member.

6. The spring structure as claimed in claim 5, wherein a part connected with the first spring member in the support post unit and a part connected with the second spring member in the floating member have a same width in a longitudinal direction of the first and second spring members.

7. The spring structure as claimed in claim 5, wherein the support post unit comprises a support post vertically arranged in the opening formed through the floating member;
the first spring member comprises a first spring connected to the support post and extending in the predetermined direction from the support post;
the second spring member comprises second and third springs connected to the floating member in the opening and extending in the same direction as the first spring from the floating member; and
the connection member comprises a connection bar arranged normal to the first, second and third springs and interconnecting the tip ends of the first, second and third springs.

8. The spring structure as claimed in claim 1, wherein the support post unit and the spring unit are provided on at least one of two opposite edges of the floating member.

9. The spring structure as claimed in claim 8, wherein the support post unit comprises first and second support posts vertically arranged in first and second slits, respectively, in which the first and second slits are formed in the one edge with a predetermined distance between them;
the first spring member comprises first and second springs connected to the first and second support posts and extending in the predetermined direction from the first and second support posts, respectively;
the second spring member comprises a third spring connected to the floating member between the first and second slits and extending in the same direction as the first and second springs from the floating member; and
the connection member comprises a connection bar arranged normal to the first, second and third springs and interconnecting the tip ends of the first, second and third springs.

10. The spring structure as claimed in claim 1, wherein the connection member is arranged normal to the first and second spring members.

11. A micro-structure comprising:
a substrate;
a floating member; and
a spring structure for supporting the floating member in such a manner that the floating member is retained in floating state above the substrate with a gap being formed between the substrate and the floating member, wherein the spring structure comprises:
at least one support post unit fixed to a substrate; and
at least one spring unit comprising a first spring member connected to the support post unit and extending in a predetermined direction from the support post unit, a second spring member connected to a floating member and extending in the same direction as the first spring member from the floating member, and a connection member interconnecting tip ends of the first and second spring members.

12. The micro-structure as claimed in claim 11, wherein the spring unit further comprises a sagging prevention member formed on the connection member to be opposite to the substrate.

13. The micro-structure as claimed in claim 12, wherein the sagging prevention member comprises at least one projection.

14. The micro-structure as claimed in claim 11, wherein a part connected with the first spring member in the support post unit, the floating member and the connection member are formed from a same material having a first thermal expansion coefficient, and
the first and second spring members are formed from a same material having a second thermal expansion coefficient.

15. The micro-structure as claimed in claim 11, wherein the support post unit and the spring unit are located in an opening formed through a central portion of the floating member.

16. The micro-structure as claimed in claim 15, wherein a part connected with the first spring member in the support post unit and a part connected with the second spring member in the floating member have a same width in a longitudinal direction of the first and second spring members.

17. The micro-structure as claimed in claim 15, wherein the support post unit comprises a support post vertically arranged in the opening formed through the floating member;
the first spring member comprises a first spring connected to the support post and extending in a predetermined direction from the support post;
the second spring member comprises second and third springs connected to the floating member in the opening and extending in the same direction as the first spring from the floating member; and
the connection member comprises a connection bar arranged normal to the first, second and third springs and interconnecting the tip ends of the first, second and third springs.

18. The micro-structure as claimed in claim 11, wherein the support post unit and the spring unit are provided on at least one of two opposite edges of the floating member.

19. A micro-structure as claimed in claim 18, wherein the support post unit comprises first and second support posts vertically arranged in first and second slits, respectively, in which the first and second slits are formed in the edge with a predetermined distance;
the first spring member comprises first and second springs connected to the first and second support posts and extending in the predetermined direction from the first and second support posts, respectively;
the second spring member comprises a third spring connected to the floating member between the first and second slits and extending in the same direction as the first and second springs from the floating member; and
the connection members comprises a connection bar arranged normal to the first, second and third springs and interconnecting the tip ends of the first, second and third springs.

20. The micro-structure as claimed in claim 11, wherein the micro-structure is a micro switch;
the substrate comprises at least one signal line, and at least one electrostatic driving unit; and
the floating member comprises a switch pad having plural terminal connection units, which come into contact with or move away from switching terminals of the signal line in response to movement of the electrostatic driving unit.

21. The micro-structure as claimed in claim 11, wherein the connection member is arranged normal to the first and second spring members.
